(19) United States
(12) Patent Application Publication
(10) Pub. No.: US 2024/0375042 A1
(43) Pub. Date: Nov. 14, 2024

(54) SUB-TEXTURED PACKING FOR GAS SEPARATION

(71) Applicant: University of Kentucky Research Foundation, Lexington, KY (US)

(72) Inventors: Jesse Thompson, Lexington, KY (US); Min Xiao, Lexington, KY (US); Kunlei Liu, Lexington, KY (US)

(21) Appl. No.: 18/660,700

(22) Filed: May 10, 2024

Related U.S. Application Data
(60) Provisional application No. 63/465,486, filed on May 10, 2023.

(51) Int. Cl. B01D 53/18; B01D 53/62; B01D 53/78; B01J 19/32

(52) U.S. Cl. CPC B01D 53/18; B01D 53/62; B01D 53/78; B01J 19/32; B01D 2257/504; B01J 2219/3221; B01J 2219/32248; B01J 2219/32408; B01J 2219/32425; B01J 2219/32483

(57) ABSTRACT

A packing for gas separation from a liquid absorbent includes a body having a corrugated surface or surface sub-texture adapted to create local turbulence within a liquid absorbent with which the body has been wetted. The body may also has a corrugated profile wherein the surface sub-texture comprises a plurality of individual scallops and the corrugated profile comprises a plurality of individual furrow with between about 2 and about 50 individual scallops per furrow. The packing is useful in a method for gas separation from a liquid absorbent.

### RELATED APPLICATIONS

This patent application claims the benefit of U.S. Provisional Patent Application Ser. No. 63/465,486, filed May 10, 2023, the full disclosure of which is incorporated herein by reference.

### STATEMENT REGARDING FEDERALLY SPONSORED RESEARCH OR DEVELOPMENT

This invention was made with government support under grant number DE-FE0031661 awarded by the U.S. Department of Energy, National Energy Technology Lab. The government has certain rights in the invention.

### TECHNICAL FIELD

This document relates generally to the gas separation field and, more particularly, to a new and improved sub-textured packing for gas separation and to its method of use.

### BACKGROUND

Packed beds and columns are often used in industry to perform various separation processes including, but not necessarily limited to distillation, absorption, and stripping. The packing provided in packed beds and columns may be structured or random. The purpose of the packing is to provide additional reaction area and enhance contact/mixing between the liquid and gas phases interacting in the packed bed/column. Increases in contact/mixing between the chemicals in the different phases improves mass transfer thereby enhancing chemical absorption.

Packing performance is greatly influenced by the structure of the packing material as this affects both the overall surface area of the packing material and the gas/liquid mixing resulting from void space between the packing material. This document relates to a new and improved packing, made from an appropriate polymer, ceramic or metal material, that has been 3D printed, cast, stamped or otherwise fabricated to include a surface sub-texture that creates local turbulence within the liquid phase absorbent that, in turn, reduces mass transfer resistance. This can enhance absorption of the reactant in gas phase allowing a given reaction to be pursued more efficiently thereby decreasing the size requirements for the packed bed/column. For various industrial applications, such as carbon dioxide capture, this can enable significant capital cost savings.

### SUMMARY

In accordance with the purposes and benefits set forth herein, a new and improved packing is provided for more efficient gas separation. The packing comprises, consists of or consists essentially of a body having surface sub-texture adapted to create local turbulence within a liquid absorbent with which the body has been wetted. For purposes of this document, “surface sub-texture” refers to depressions, elevations and/or ridges at a scale of about 0.1-0.5 mm extending across the valleys and peaks formed by the profile of the body.

In at least some of the many possible embodiments, the body has a corrugated profile. In at least some embodiments, the surface sub-texture comprises a plurality of individual scallops, forming a corrugated surface, and the corrugated profile comprises a plurality of individual furrows.

In some embodiments, the body includes between about 2 and about 50 individual scallops per furrow. Each of the individual scallops may have a width-to-height ratio of between about 2:1 and about 10:1. Each of the individual furrows may have a width-to-height ratio of between about 10:1 and about 500:1.

In some embodiments, each individual scallop has an amplitude (height) of between about 0.1 mm and about 1.0 mm and a frequency (width) of between about 1.0 mm and about 10.0 mm. In some embodiments, each individual furrow has an amplitude of between about 1.0 mm and about 5.0 mm and a frequency of between about 5.0 mm and about 20 mm.

In some embodiments of the packing, the plurality of scallops are all of the same size and the plurality of furrows are all of the same size. In some embodiments of the packing, the plurality of scallops are all of the same size and the plurality of furrows are of various different sizes. In some embodiments of the packing, the plurality of the scallops are of various different sizes and the plurality of the furrows are all of the same size. In some embodiments of the packing, the plurality of the scallops are of various different sizes and the plurality of furrows are of various different sizes.

The body may be made from a polymer material, a metal material or a ceramic material. Polymer materials useful in construction of the packing include, but are not necessarily limited to, polylactic acid (PLA), acrylonitrile butadiene styrene (ABS), high impact polystyrene (HIPS), nylon, poly(ethylene terephthalate)-mod-ethylene glycol (PETG), poly(vinyl butyral) PVB), copolyester, poly(cyclohexylenedimethyllene terephthalate)-mod-ethylene glycol (PCTG), upcycled high impact polystyrene (U-HIPS), polypropylene (PP), polypropene, high performance water soluble fimament, polyphenyl sulfone, (PPSU), polyvinylchloride (PVC), polyphenylene ether (PPE-PS), polyvinylidene fluoride (PVDF), thermoplastic polyurethance (TPU), olefin block copolymer, polysulfone (PSU), poly(ethylene succinate) (PES), polycarbonate-polybutylene terephthalate (PC-PBT), acrylonitrile styreneacrylate (ASA), natural fiber composite co-polyester (NFC CPE), thermoplastic copolyester (TPC), polyphenylene sulfide (PPS), polyetheretherketone (PEEK) and mixtures thereof.

In accordance with yet another aspect, a method is provided for gas separation from a liquid absorbent. That method comprises, consists of or consists essentially of contacting mixed gas and liquid phases with a packing material including a body having a surface sub-texture or corrugated surface adapted to create local turbulence within a liquid absorbent with which the body has been wetted.

The method may further include creating local turbulence by flowing the liquid absorbent over the surface sub-texture including a plurality of scallops having an amplitude (height) of between about 0.1 mm and about 1.0 mm and a frequency (width) of between about 1.0 mm and about 10.0 mm.

The method may further include flowing the liquid absorbent over the body having a corrugated profile including a plurality of furrows wherein each furrow has an amplitude (height) of between about 1.0 mm and about 5.0 mm and a frequency (width) of between about 5.0 mm and about 20 mm.

Still further, the method may further include flowing the liquid absorbent over the body including a plurality of individual scallops and a plurality of individual furrows wherein there are between about 2 to about 50 individual scallops per furrow.

In the following description, there are shown and described several different embodiments of the new and improved packing and related method for gas separation from a liquid absorbent. As it should be realized, the packing and method are capable of other, different embodiments and their several details are capable of modification in various, obvious aspects all without departing from the method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the packing and its method of use and together with the description serve to explain certain principles thereof. A person of ordinary skill in the art will readily recognize from the following discussion that alternative embodiments of the illustrated structures and methods may be employed without departing from the principles described below.

FIG. 1 is a perspective view of a prior art packing having a body with relatively smooth faces or surfaces.

FIG. 2 is a perspective view of the new and improved packing wherein the body thereof includes a surface sub-texture that forms a corrugated surface.

FIG. 3 is a perspective view showing the packing of FIG. 2 held within an absorber column.

FIG. 4A illustrates the flow of a gas across the relatively smooth surface of a prior art packing having a body with relatively smooth faces or surfaces as illustrated in FIG. 1.

FIG. 4B illustrates the flow of a gas across the corrugated or wavy surface of the new and improved packing having a polymer, ceramic or metal body with corrugated faces or surfaces as illustrated in FIG. 2.

Reference will now be made in detail to the present preferred embodiments of the apparatus and method.

### DETAILED DESCRIPTION

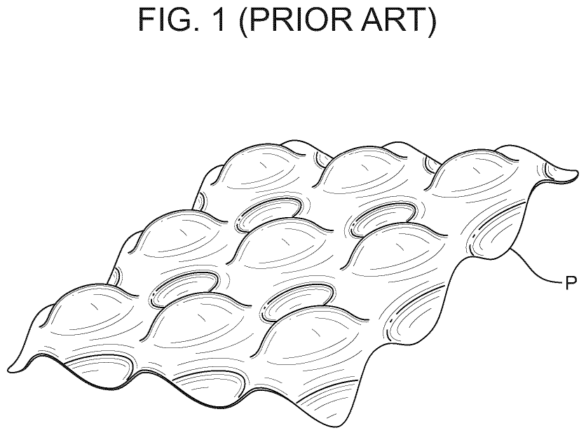

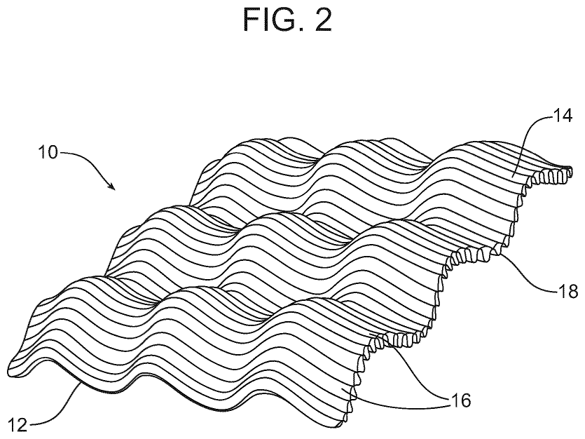

FIG. 1 illustrates a state-of-the-art packing P that includes a wavy profile with relatively smooth faces. FIG. 2 illustrates the new and improved packing 10 having a body 12 with corrugated surfaces 14, that is actual surface sub-texture formed in the faces of the body, that are adapted to create local turbulence within a liquid absorbent with which the body has been wetted. In the illustrated embodiment, the body 12 also has a corrugated or wavy profile similar to the prior art body of FIG. 1. Here, it should be appreciated that the body 12 may assume other profiles.

More particularly, in the illustrated embodiment the corrugated surfaces 14 each include a plurality of individual scallops 16 formed in the faces of the body and the corrugated profile includes a plurality of individual furrows 18 formed by the body. There are between about 5 and 50 individual scallops 16 per furrow 18. Each individual scallop 16 may have a width-to-height ratio of between about 2:1 and about 10:1. Each of the individual furrows 18 may have a width-to-height ratio of between about 10:1 and about 500:1. The scallops 16 may have an amplitude of between about 0.1 millimeter (mm) and about 1 mm and a frequency of between about 1 mm and about 10 mm. The furrows may have an amplitude of between about 1 mm and about 5 mm and a frequency of between about 5 mm and about 20 mm. The scallops 16 and the furrows 18 are intentionally made in the body 12 and may be a repeat pattern or random.

In some embodiments all of the scallops 16 are the same size. In other embodiments, the scallops 16 may vary in size across the indicated size range. Still further, in some embodiments all of the furrows 18 are the same size. In other embodiments, the furrows 18 may vary in size across the indicated size range.

The body 12 may be made from (a) a polymer material, (b) a metal material, such as stainless steel, or (c) a ceramic material via casting, stamping or 3D printing.

In one possible embodiment, the body 12 may be made from a polymer material selected from a group consisting of polylactic acid (PLA), acrylonitrile butadiene styrene (ABS), high impact polystyrene (HIPS), nylon, poly(ethylene terephthalate)-mod-ethylene glycol (PETG), poly(vinyl butyral) PVB), copolyester, poly(cyclohexylenedimethyllene terephthalate)-mod-ethylene glycol (PCTG), upcycled high impact polystyrene (U-HIPS), polypropylene (PP), polypropene, high performance water soluble fimament, polyphenyl sulfone, (PPSU), polyvinylchloride (PVC), polyphenylene ether (PPE-PS), polyvinylidene fluoride (PVDF), thermoplastic polyurethance (TPU), olefin block copolymer, polysulfone (PSU), poly(ethylene succinate) (PES), polycarbonate-polybutylene terephthalate (PC-PBT), acrylonitrile styreneacrylate (ASA), natural fiber composite co-polyester (NFC CPE), thermoplastic copolyester (TPC), polyphenylene sulfide (PPS), polyetheretherketone (PEEK) and mixtures thereof.

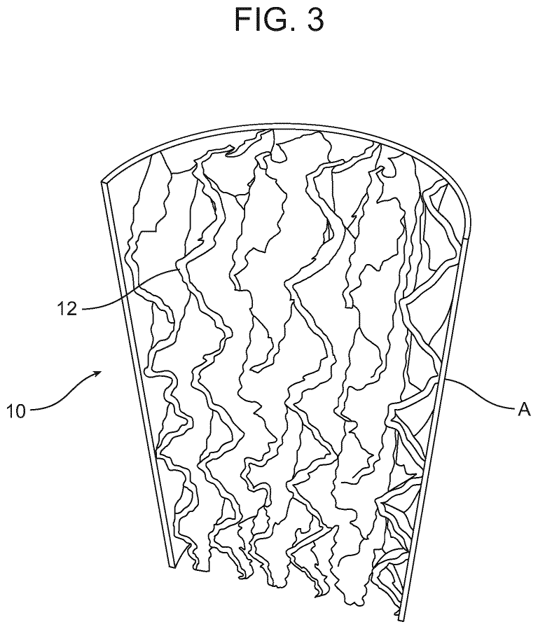

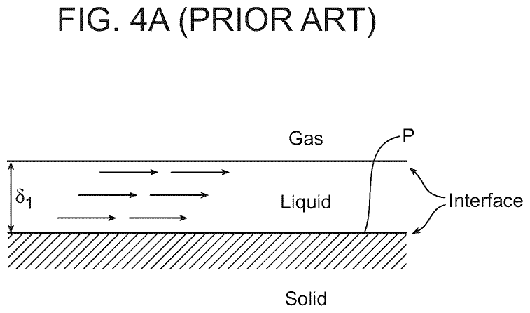

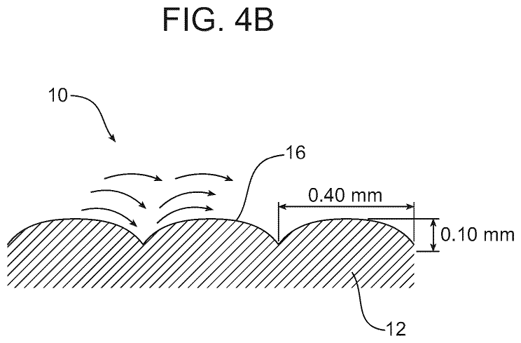

FIG. 3 illustrates the new and improved packing 10 within a portion of a wall of an absorber column or tower A such as used for the recovery of carbon dioxide from a flue gas or other acid gas. FIG. 4A illustrates how a liquid absorbent flows smoothly with little to no turbulence (note action arrows) over packing including smoother sidewalls as characterized by the prior art packing illustrated in FIGS. 1 and 4A. In contrast, note the local turbulence within a liquid absorbent (note action arrows) promoted by the surface sub-texture of the corrugated surface 14 of the packing 10 of the present disclosure illustrated in FIGS. 2 and 4B. This local turbulence reduces mass transfer diffusion resistance thereby enhancing absorption of the gas phase. This, in turn, allows a given reaction to be completed more efficiently thereby decreasing the size requirements for the packed bed/column.

A method of making the packing 10 may be said to include the step of 3D printing or casting or stamping the polymer/metal/ceramic body 12 having a corrugated surface 14 adapted to create local turbulence within a liquid absorbent with which the body has been wetted.

The method may include 3D printing (a) the corrugated surface 14 with a plurality of individual scallops 16 and (b) the corrugated profile with a plurality of individual furrows 18. The method may also include 3D printing between about 5 and about 50 individual scallops 16 per furrow 18. Each of the individual scallops 16 may be printed with a width-to-height ratio of between about 2:1 and about 10:1. Each individual furrow 18 may be printed with a width-to-height ratio of between about 10:1 and about 500:1. When the packing material is a polymer, the method may also include 3D printing the polymer body 12 from a material selected from a group consisting of polylactic acid (PLA), acrylonitrile butadiene styrene (ABS), high impact polystyrene (HIPS), nylon, poly(ethylene terephthalate)-mod-ethylene glycol (PETG), poly(vinyl butyral) PVB), copolyester, poly(cyclohexylenedimethyllene terephthalate)-mod-ethylene glycol (PCTG), upcycled high impact polystyrene (U-HIPS), polypropylene (PP), polypropene, high performance water soluble fimament, polyphenyl sulfone, (PPSU), polyvinylchloride (PVC), polyphenylene ether (PPE-PS), polyvinylidene fluoride (PVDF), thermoplastic polyurethance (TPU), olefin block copolymer, polysulfone (PSU), poly(ethylene succinate) (PES), polycarbonate-polybutylene terephthalate (PC-PBT), acrylonitrile styreneacrylate (ASA), natural fiber composite co-polyester (NFC CPE), thermoplastic copolyester (TPC), polyphenylene sulfide (PPS), polyetheretherketone (PEEK) and mixtures thereof.

The packing 10 is useful in a method for gas separation. That method includes the step of contacting mixed gas and liquid phases with the packing material 10 including the body 12 having a corrugated surface 14 adapted to create local turbulence within a liquid absorbent with which the body has been wetted.

More specifically, the method includes creating local turbulence by flowing the liquid absorbent over the subsurface texture of the corrugated surface including a plurality of scallops having an amplitude of between about 0.1 mm and about 1.0 mm and a frequency of between about 1.0 mm and about 10.0 mm. Further, the method may include flowing the liquid absorbent over the body 12 having a corrugated profile including a plurality of furrows having an amplitude of between about 1.0 mm and about 5.0 mm and a frequency of between about 5.0 mm and about 20 mm.

Still further, the method may include flowing the liquid absorbent over the body including a plurality of individual scallops and a plurality of individual furrows wherein there are between about 2 to about 50 individual scallops per furrow.

This disclosure may be said to relate to the following items.
1. A packing, comprising: a body having a surface sub-texture adapted to create local turbulence within a liquid absorbent with which the body has been wetted.
2. The packing of item 1, wherein the body also has a corrugated profile.
3. The packing of item 2, wherein the surface sub-texture comprises a plurality of individual scallops and the corrugated profile comprises a plurality of individual furrows.
4. The packing of item 3, including between about 2 and about 50 individual scallops per furrow.
5. The packing of item 4, wherein each of the individual scallops has a width-to-height ratio of between about 2:1 and about 10:1.
6. The packing of item 5, wherein each of the individual furrows has a width-to-height ratio of between about 10:1 and about 500:1.
7. The packing of item 4, wherein each of the individual furrows has a width-to-height ratio of between about 10:1 and about 500:1.
8. The packing of item 3 wherein each individual scallop has an amplitude of between about 0.1 mm and about 1.0 mm and a frequency of between about 1.0 mm and about 10.0 mm.
9. The packing of item 8, wherein each individual furrow has an amplitude of between about 1.0 mm and about 5.0 mm and a frequency of between about 5.0 mm and about 20 mm.
10. The packing of item 1, wherein the body is made from a polymer material selected from a group consisting of polylactic acid (PLA), acrylonitrile butadiene styrene (ABS), high impact polystyrene (HIPS), nylon, poly(ethylene terephthalate)-mod-ethylene glycol (PETG), poly(vinyl butyral) PVB), copolyester, poly(cyclohexylenedimethyllene terephthalate)-mod-ethylene glycol (PCTG), upcycled high impact polystyrene (U-HIPS), polypropylene (PP), polypropene, high performance water soluble fimament, polyphenyl sulfone, (PPSU), polyvinylchloride (PVC), polyphenylene ether (PPE-PS), polyvinylidene fluoride (PVDF), thermoplastic polyurethance (TPU), olefin block copolymer, polysulfone (PSU), poly(ethylene succinate) (PES), polycarbonate-polybutylene terephthalate (PC-PBT), acrylonitrile styreneacrylate (ASA), natural fiber composite co-polyester (NFC CPE), thermoplastic copolyester (TPC), polyphenylene sulfide (PPS), polyetheretherketone (PEEK) and mixtures thereof.
11. The packing of item 1, wherein the body is made from a ceramic material.
12. The packing of item 1, wherein the body is made from a metal material.
13. The packing of item 4, wherein the plurality of scallops are all of the same size and the plurality of furrows are all of the same size.
14. The packing of item 13, wherein the plurality of scallops are all of the same size and the plurality of furrows are of various different sizes.
15. The packing of item 13, wherein the plurality of the scallops are of various different sizes and the plurality of the furrows are all of the same size.
16. The packing of item 13, wherein the plurality of the scallops are of various different sizes and the plurality of furrows are of various different sizes.
17. A method for gas separation from a liquid absorbent, comprising: contacting mixed gas and liquid phases with a packing material including a body having a surface sub-texture adapted to create local turbulence within a liquid absorbent with which the body has been wetted.
18. The method of item 17, further including creating local turbulence by flowing the liquid absorbent over the surface sub-texture including a plurality of scallops having an amplitude of between about 0.1 mm and about 1.0 mm and a frequency of between about 1.0 mm and about 10.0 mm.
19. The method of item 18, further including flowing the liquid absorbent over the body having a corrugated profile including a plurality of furrows having an amplitude of between about 1.0 mm and about 5.0 mm and a frequency of between about 5.0 mm and about 20 mm.
20. The method of item 17, including flowing the liquid absorbent over the body including a plurality of individual scallops and a plurality of individual furrows wherein there are between about 2 to about 50 individual scallops per furrow.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a surface”, as used herein, may also refer to, and encompass, a plurality of surfaces.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the packing and method of making the same of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A packing, comprising: a body having a surface sub-texture adapted to create local turbulence within a liquid absorbent with which the body has been wetted.

2. The packing of claim 1, wherein the body also has a corrugated profile.

3. The packing of claim 2, wherein the surface sub-texture comprises a plurality of individual scallops and the corrugated profile comprises a plurality of individual furrows.

4. The packing of claim 3, including between about 2 and about 50 individual scallops per furrow.

5. The packing of claim 4, wherein each of the individual scallops has a width-to-height ratio of between about 2:1 and about 10:1.

6. The packing of claim 5, wherein each of the individual furrows has a width-to-height ratio of between about 10:1 and about 500:1.

7. The packing of claim 4, wherein each of the individual furrows has a width-to-height ratio of between about 10:1 and about 500:1.

8. The packing of claim 3 wherein each individual scallop has an amplitude of between about 0.1 mm and about 1.0 mm and a frequency of between about 1.0 mm and about 10.0 mm.

9. The packing of claim 8, wherein each individual furrow has an amplitude of between about 1.0 mm and about 5.0 mm and a frequency of between about 5.0 mm and about 20 mm.

10. The packing of claim 1, wherein the body is made from a polymer material selected from a group consisting of polylactic acid (PLA), acrylonitrile butadiene styrene (ABS), high impact polystyrene (HIPS), nylon, poly(ethylene terephthalate)-mod-ethylene glycol (PETG), poly(vinyl butyral) PVB), copolyester, poly(cyclohexylenedimethyllene terephthalate)-mod-ethylene glycol (PCTG), upcycled high impact polystyrene (U-HIPS), polypropylene (PP), polypropene, high performance water soluble fimament, polyphenyl sulfone, (PPSU), polyvinylchloride (PVC), polyphenylene ether (PPE-PS), polyvinylidene fluoride (PVDF), thermoplastic polyurethance (TPU), olefin block copolymer, polysulfone (PSU), poly(ethylene succinate) (PES), polycarbonate-polybutylene terephthalate (PC-PBT), acrylonitrile styreneacrylate (ASA), natural fiber composite co-polyester (NFC CPE), thermoplastic copolyester (TPC), polyphenylene sulfide (PPS), polyetheretherketone (PEEK) and mixtures thereof.

11. The packing of claim 1, wherein the body is made from a ceramic material.

12. The packing of claim 1, wherein the body is made from a metal material.

13. The packing of claim 4, wherein the plurality of scallops are all of the same size and the plurality of furrows are all of the same size.

14. The packing of claim 13, wherein the plurality of scallops are all of the same size and the plurality of furrows are of various different sizes.

15. The packing of claim 13, wherein the plurality of the scallops are of various different sizes and the plurality of the furrows are all of the same size.

16. The packing of claim 13, wherein the plurality of the scallops are of various different sizes and the plurality of furrows are of various different sizes.

17. A method for gas separation from a liquid absorbent, comprising: contacting mixed gas and liquid phases with a packing material including a body having a surface sub-texture adapted to create local turbulence within a liquid absorbent with which the body has been wetted.

18. The method of claim 17, further including creating local turbulence by flowing the liquid absorbent over the surface sub-texture including a plurality of scallops having an amplitude of between about 0.1 mm and about 1.0 mm and a frequency of between about 1.0 mm and about 10.0 mm.

19. The method of claim 18, further including flowing the liquid absorbent over the body having a corrugated profile including a plurality of furrows having an amplitude of between about 1.0 mm and about 5.0 mm and a frequency of between about 5.0 mm and about 20 mm.

20. The method of claim 17, including flowing the liquid absorbent over the body including a plurality of individual scallops and a plurality of individual furrows wherein there are between about 2 to about 50 individual scallops per furrow.
